(19) United States
(12) Patent Application Publication
(10) Pub. No.: US 2004/0015476 A1
(43) Pub. Date: Jan. 22, 2004

(54) Method and system for dynamic web-page generation, and computer-readable storage

(76) Inventor: Graham Kennedy Twaddle, Argyl ?amp; Bute (GB)

Correspondence Address: Watov & Kipnes, P O Box 247, Princeton Junction, NJ, 08550, US

(21) Appl. No.: 10/363,375

(22) PCT Filed: Aug. 31, 2001
(86) PCT No.: PCT/GB01/03916

(30) Foreign Application Priority Data
Sep. 1, 2000 (GB) 0021513.7

(51) Int. Cl. G06F 7/00

(52) U.S. Cl. 707/1

(57) ABSTRACT

A method and system to dynamically generate user specific web-page which are capable of providing user specific information content personal to that particular user in combination with other more generic content. A user template is stored on a database, with the template containing hierarchical references to data structures which may contain personal user specific information. The data structures and/or pointer thereto are then compiled in sequence in accordance with the hierarchical references in order to create the web-page.

The present invention relates to automatic creation of web-pages for transmission over the Internet to a user for displaying as a World Wide web-page, and more particularly to a method of dynamic creation of such web-pages which allows for the provision of different web-pages to a plurality of users.

The recent growth of the Internet, and in particular that part of the Internet known as the World Wide web has placed increasing technological demands on the hardware and software upon which the World Wide web is based, and in particular with regards to how many users a particular web server can service concurrently.

In addition, there has been a recent trend for website providers to provide web-pages customised to each user registered with the website, with each user web-page containing information content relating to fixed categories which have been pre-selected by the user from a menu. Such user specific web-pages are commonly known as “portals” as the user specific web-page acts as a portal or conduit for the user to obtain the information corresponding to the pre-selected categories which the user selected upon registration with the portal website. As an example, the pre-selected categories could be such categories as current affairs, sport, entertainment, technology, etc. etc.

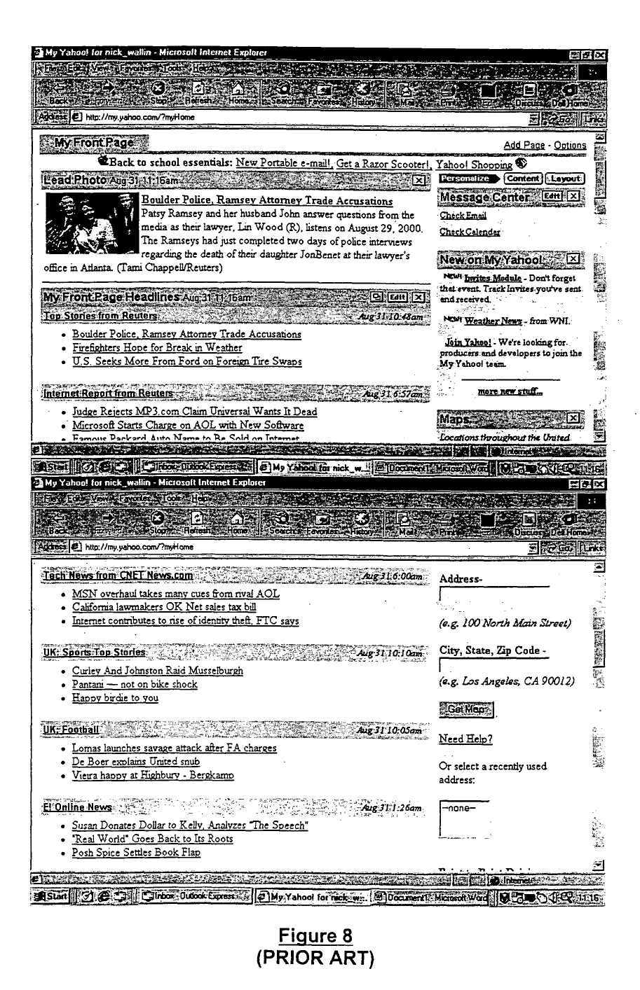

A prior art example of a portal website is that found at http://my.yahoo.com, which is described in detail in EP-0889421A in the name of Yahoo Inc. In addition, screen shots from a portal web-page provided from my.yahoo.com are shown in FIG. 8.

With reference to FIG. 8, FIG. 8 shows two screen dumps taken from the same web-page displayed on a web browser (in this case Microsoft Internet Explorer). Each screen dump shows a different part of the same web-page, as will be clear from the position of the scroll bar at the far right of the screen. With respect to the web-page, you will see that the page contains links to news items relating to several different categories, such as, current affairs, technological news, and UK sports stories. These categories were selected by the user for whom the page was created when the user registered with the website, from a limited list of categories provided by the website.

EP-0889421 describes how a web-page such as that depicted in FIG. 8 is created. More particularly, within the prior art the web-page of FIG. 8 is created by a page server which is provided with user preferences organised into templates stored in compact data structures and the live data used to fill the templates is stored local to the page server which is handling user requests for custom pages. One process is executed on the page server for every request. The process is provided with a user template for the user making the request, where the user template is generated from user preferences as to the desired content, as explained previously. Each user process is then provided with access to a large region of shared memory which contains all of the live data needed to fill any user template. As shown in FIG. 8, typically the pages served are news pages containing current affairs headlines, sports scores, technology news, and the like. The actual information content for each of these categories is obtained by the website polling remote web servers which each deal with the specific information category (eg. Reuters for current affairs, CSPN for sports, CNET News for technology news, etc.), and the gathered data is then stored in the shared memory. With the live data then stored in the shared memory any custom page can be built within the page server eliminating the need to make requests from the other servers for portions of the live data. The shared memory in which the collected data content is stored is preferably random access memory.

The my.yahoo.com system architecture as described above has the advantage that user specific dynamic pages may be created quickly in response to a user request due to the fact that all of the live data is stored in a local shared memory, but has disadvantage that as the live data is stored in a shared memory then the memory must be large in order to provide for a large number of categories of content from which the user may request. In addition, apart from selecting the categories which will appear on his web-page, a user has no further control over the actual content which appears in those categories, as this is merely shared content from the local shared memory. Therefore, it is not possible for the user to access personal information such as for example, bank account or medical records using such a dynamic page creation system.

It has recently become possible, however, for high numbers of multiple concurrent users to obtain personal information from legacy databases such as those maintained by banks, health authorities, insurance companies, etc. in the form of web-pages over the Internet for display using a web browser. In particular, International Patent Application WO-A-0133388 published on May 10, 2001 in the name of Sherwood International Group Ltd. discloses a method and system for multi-user access of a database over the Internet which provides for web-page creation containing user specific personal data obtained from a legacy back-end system such as those maintained by banks, insurance companies, etc. Here, when a web-page containing user specific data is requested by a user, an application server receives the request from the website server, and interfaces with the legacy back-end system to obtain the requested user specific information. The user specific information is usually stored on a legacy database system which is incapable of dynamically processing multiple concurrent requests. In order to get around this problem, WO-A-0133388 introduces the concept of multiple types of user specific web-pages, being those user specific web-pages wherein the information thereon does not change, being static web-pages, user specific web-pages wherein the information content only changes periodically, and can therefore be considered semi-static, and finally user specific web-pages wherein the information content can change in real time, and therefore the web-page can be considered to be dynamic. In order to provide for service to multiple concurrent users, the system of WO-A-0133388 stores user specific static and semi-static web-pages in a file system for access by the application server when requested, and performs periodic batch processing in order to update the information content on the semi-static pages. With respect to the creation of dynamic pages, a mail-merge technique is used wherein the application server interfaces with a database controller to access the required information from the legacy database, and the required information is then mail-merged into a web-page template in order to create a dynamic web-page. The statistical division of web-pages into static, semi-static and dynamic pages, as described above allows for a greater number of multiple concurrent users to be serviced than would otherwise be the case.

The present invention improves upon the above-described prior art by applying the statistical division of web-pages into two or more types as described in WO-A-0133388 to the dynamic creation of users specific web-pages for use on a portal website. In particular, it is an object of the present invention to dynamically generate user specific web-pages which are capable of providing user specific information content personal to that particular user in combination with other more generic content.

In order to meet the above object, the present invention provides a method and system which makes use of user specific templates which contain hierarchical references to data structures which may contain personal user specific information. The data structures and/or a pointer thereto are then compiled in sequence in accordance with the hierarchical references in order to create the web-page.

Therefore, from a first aspect the present invention provides a method of dynamic web-page generation comprising the steps of:

retrieving a user template from a database, said template containing one or more hierarchical references to one or more web-page component data structures;

parsing the retrieved user templates sequentially to determine the taxonomy of the hierarchical references; and

compiling at least a pointer to each referenced page component data structure sequentially in accordance with the taxonomy of the hierarchical references to create a web-page containing at least one pointer to each of the referenced data structures;

wherein each page component data structure is one of a locally stored pre-created structure, a dynamically created structure, or a remotely stored structure.

Preferably, the hierarchical references may have multiple levels, and each referenced data structure may be at a different hierarchical level than other referenced data structures. In addition, rather than pointing to a data component data structure, a hierarchical reference may point to an executable command which upon execution dynamically creates a page component data structure which can then be compiled into the web-page. Moreover, rather than merely compiling a pointer to each referenced data structure, the content of the referenced data structure may be directly incorporated into the generated web-page source code.

Furthermore, the page component data structures pointed to by the hierarchical references may be remote web-page components provided on a remote website operated by a content supplier. In this case, the hierarchical reference includes the universal resource locater of the website of the content supplier. Preferably, the universal resource locater is compiled into the web-page rather than the actual page component data structure pointed at by the universal resource locater.

Where the page component data structure is locally stored, the page component data structure may be a static data structure, or may alternatively be a semi-static data structure containing user specific information which is periodically batch updated.

In the preferred embodiment, user specific information is stored on a legacy database, and an application server is preferably provided to access information from the database to form the page component data structures which can be compiled into the web-page.

From another aspect, the present invention also provides a system providing dynamic web-page generation, the system comprising user template storage means arranged to store one or more user templates, each template containing one or more hierarchical references to one or more page component data structures;

parsing means arranged to retrieve a user template from the user template storage means, and to parse the retrieved user template sequentially to determine the taxonomy of the hierarchical references stored therein; and

page compiler means arranged to compile at least a pointer to each reference page component data structure sequentially in accordance with the taxonomy of the hierarchical references determined by the parser means, to create a web-page containing at least a pointer each referenced data structure; and

a local file system means arranged to store page component data structures thereon;

wherein each page component data structure is one of a locally stored pre-created structure, a dynamically created structure, or a remotely stored structure.

Preferably, the system further comprises a database containing user specific personal information; and

an application server arranged to access the database to retrieve user specific personal information therefrom, and to create page component data structures containing the retrieved user specific personal information. Preferably the application server saves the created page component data structures in the local file system storage means.

In addition, from another aspect the present invention provides a computer readable storage medium storing a program arranged to perform a method of dynamic web-page generation, the program controlling the steps of:

retrieving a user template from a database, said template containing one or more hierarchical references to one or more page component data structures;

parsing the retrieved user templates sequentially to determine the taxonomy of the hierarchical references; and

compiling at least a pointer to each referenced page component data structure sequentially in accordance with the taxonomy of the hierarchical references to create a web-page containing at least a pointer to the reference data structures;

wherein each page component data structure is one of a locally stored pre-created structure, a dynamically created structure, or a remotely stored structure.

It is a primary feature of the present invention that each user registered with the portal website has saved a template containing hierarchical references to web-page component data structures. The hierarchical references are in the form of # include commands to other files or data structures further down the hierarchy. Furthermore, it is a further feature that the respective files pointed to by the respective # include commands in the template may include further # include commands to other files or data structures lower down the hierarchy.

It is a further feature that the user specific web-pages are dynamically created by compiling the referenced data structures sequentially in accordance with the hierarchical references. That is, each page is generated by parsing the top level user template containing one or more # include commands and following each # include command from the root # include command in the template to the referenced file and then parsing the referenced file sequentially and following any further references in the form of further # include commands in the reference file in turn, until the referenced data structure or pointer to a data structure is obtained at what will be termed the “leaf” of the hierarchical reference.

It is an advantage of the present invention that the hierarchical nature in which the user specific web-page is dynamically generated allows for fixed content to be merged with dynamic content in the form of personal user specific information, such as, for example bank account details, medical records, insurance policy details, etc.

There is a further advantage of the present invention that by combining the hierarchical page generation method with the statistical division of web-pages into two or more types (ie. such as static, semi-static and dynamic) as described in WO-A-0133388 then user specific portal web-pages can be dynamically generated which contain personal user specific information to service large numbers of multiple concurrent users.

Further features and advantages of the present invention will become apparent from the following description of a particularly preferred embodiment thereof, presented by way of example only, and by reference to the accompanying drawings, wherein

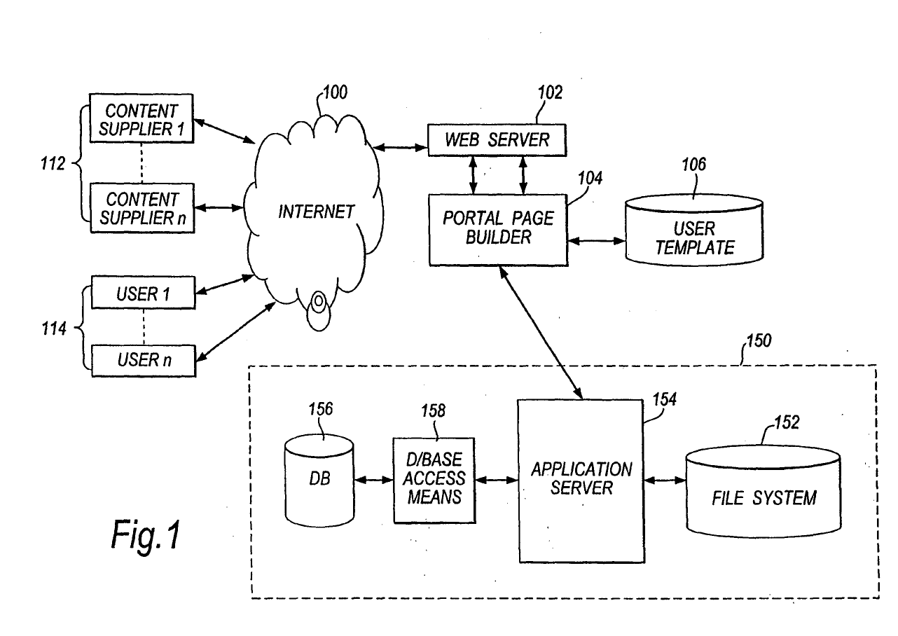

FIG. 1 shows a system-architecture block diagram of the system according to the present invention;

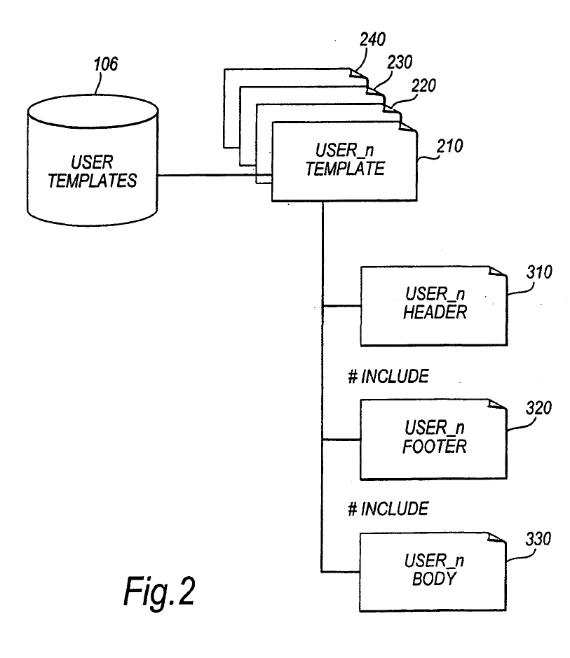

FIG. 2 illustrates the top level hierarchical structure of a user template used in the present invention;

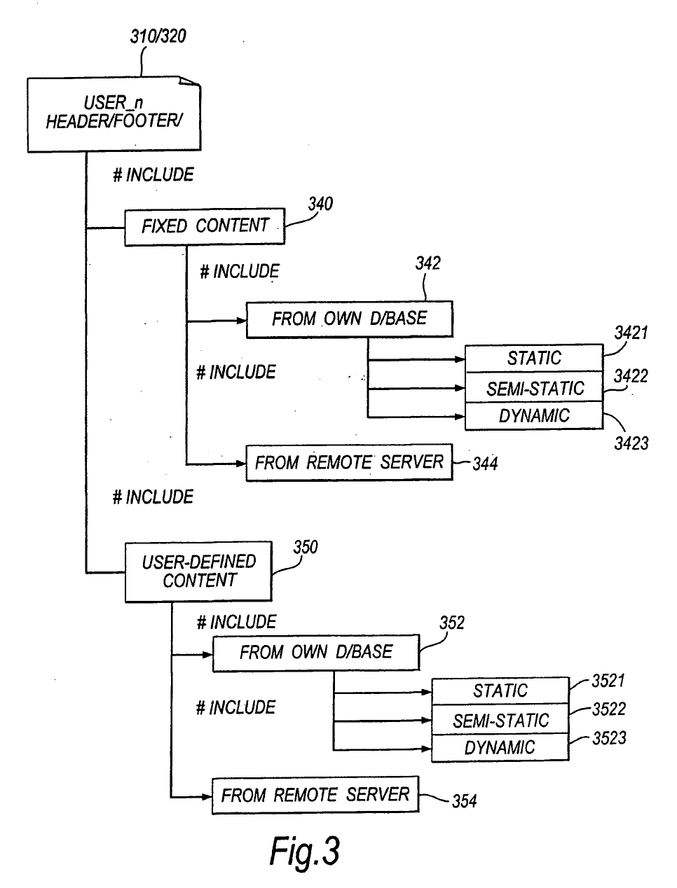

FIG. 3 illustrates the hierarchical manner in which the headers and footers of a user specific web-page of the present invention can be constructed;

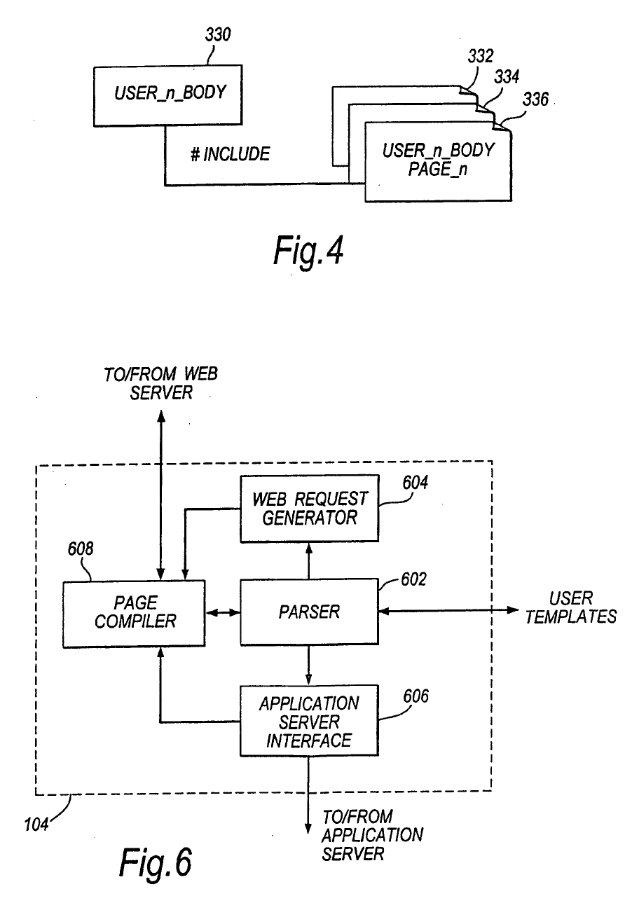

FIG. 4 illustrates how a body portion of the user specific web-page may contain multiple pages;

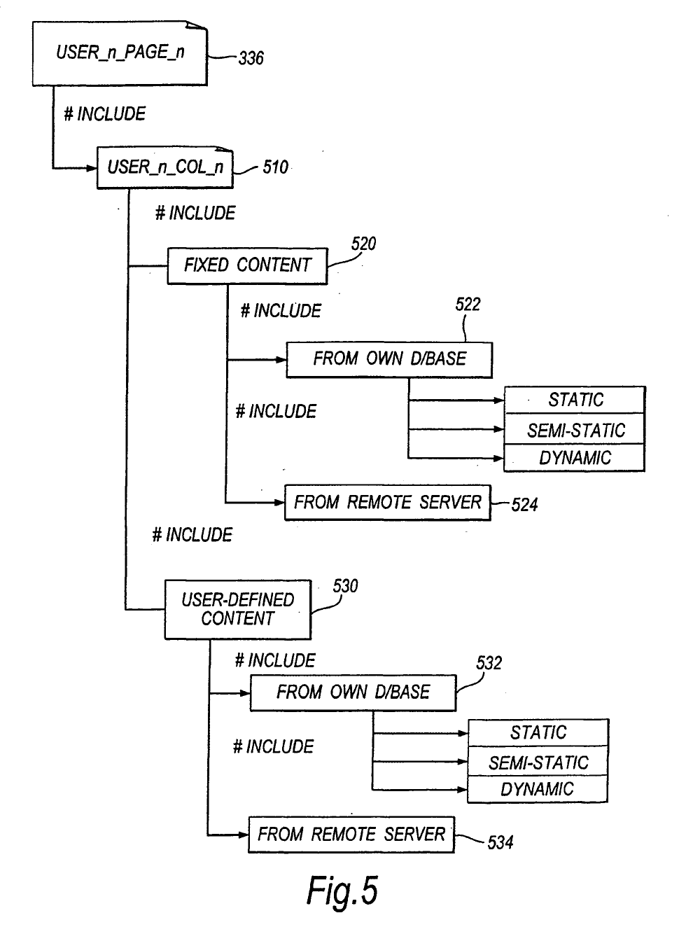

FIG. 5 illustrates the hierarchical manner in which a page on the user specific web-page may be constructed;

FIG. 6 is a system block diagram of the portal page builder module used in the present invention;

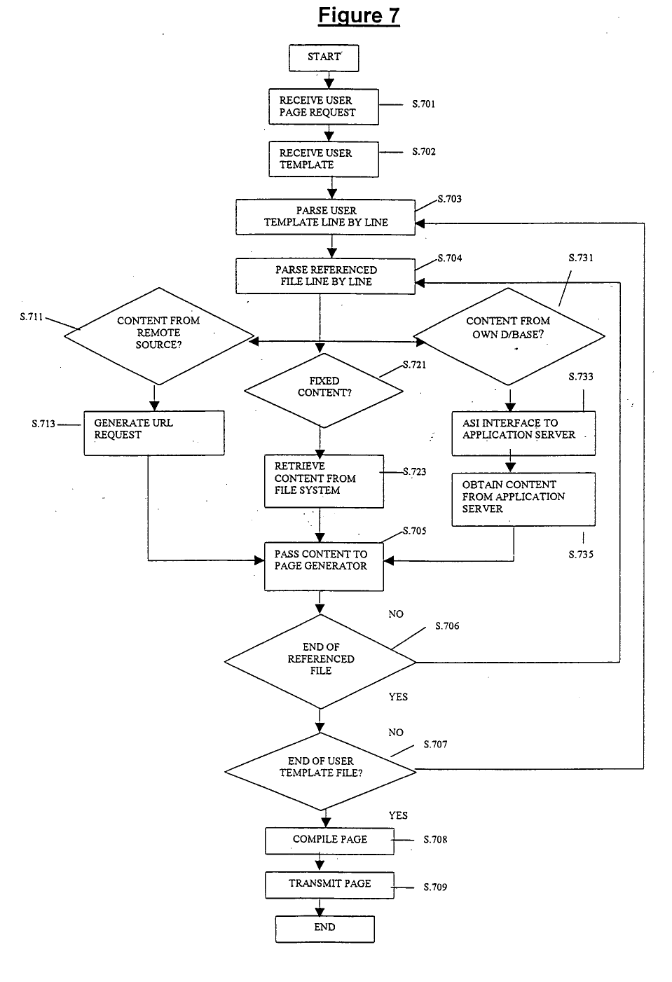

FIG. 7 is a flow diagram of the operation of the portal page builder module used in the present invention; and

FIG. 8 is a screen shot of a prior art user specific portal web-page.

In addition to the accompanying drawings, Appendix A contains a real-word example of web-page source code for a particular user's portal web-page from which the intended reader skilled in the art will see that the code is hierarchical.

The present invention builds upon the method and system for multi-user access of the database disclosed in WO-A-0133388 the relevant disclosure of which necessary for a full understanding of the present invention being incorporated herein by reference. An embodiment of the method and system disclosed in WO-A-0133388 is commercially available in the form of the “AEOS” Internet cartridge from Sherwood International Group Ltd.

Bearing the above in mind, an embodiment of the present invention will now be described with reference to the accompanying drawings.

In FIG. 1, a portal website (not shown) is provided on a web server 102 which is arranged to service user 114 requests for access to the portal web-pages over the Internet 100. The web server 102 interfaces with a portal page builder module 104 which is arranged to dynamically build user specific web-pages in response to a request from the user transmitted to the portal page builder module 104 from the web server 102. The portal page builder module 104 retrieves a pre-created user template specific to a particular user from a user template storage means 106, and is further arranged to retrieve personal user specific data from a back-end system 150. The back-end system 150 comprises an application server 154, a legacy database 156 containing user specific records such as, for example, bank account details, medical records, etc., and a database access means 158 arranged to query the database 156 to retrieve data therefrom. In addition, a file system 152 is provided in order to provide file storage for the application server 154. In the preferred embodiment the back-end system 150 generally corresponds to the system for providing multi-user access to a database over the World Wide web described in WO-A-0133388.

The operation of the system architecture of FIG. 1 can be described as follows. Suppose a user n 114 requests access to his user specific portal web-page containing information which he has pre-selected upon registration with the website. The user transmits his page request over the Internet 100 to the web server 102, who passes the request to the page builder 104. The page builder 104 obtains the user n's template from the user template storage medium 106, and proceeds to parse the user template to determine the content that must be merged into the template. The template is parsed line-by-line, and pointers to the files or data structures referenced therein are passed to the application server which acts to retrieve the referenced files or data structures either from the file system 152 in the case of static or semi-static content, or to dynamically create the reference data structure by accessing the legacy database 156 to retrieve the personal user data and mail-merging the retrieved data into a file template stored in the application server. The application server then passes back the referenced files or data structures to the portal page builder module 104 upon request, and the portal page builder module 104 compiles the received files or data structures in turn to create the user web-page.

In addition to obtaining content provided from the back-end system 150, it is also possible for the portal page builder 104 to obtain content from one or more remote contents suppliers 112, in which case a file pointer in the form of a universal resource locater (URL) is included in the web-page source code compiled by the portal page builder 104.

Once the portal page builder has compiled the web-page source code the source code is passed to the web server for transmission over the Internet to the user 114, who displays the source code using a standard web browser.

The compiled source code generated by the portal page builder module 104 may be in any mark-up language, but in particular HTML, XML, and WML are envisaged.

In addition, as an alternative to including a pointer to an external content supplier 112 in the form of a URL, it may be possible for the portal page builder to generate a page request which is transmitted by the web server 102 over the Internet 100 to the content supplier's website, which then provides the requested content via the Internet 100 and web server 102, and the portal page builder module 104 incorporates the content direct into the compiled source code. Further details of this alternative operation are described later.

The hierarchical method by which the portal page builder module 104 compiles the web-page source code will now be described with reference to FIGS. 2 to 5.

With reference to FIG. 2, user template storage means 106 stores a plurality (210, 220, 230, 240) of pre-created user templates, saved when a particular user n first registered with the website. Each user n template 210 contains a list of file references in the form of # include commands to files or data structures stored on either the user template storage means 106 or more preferably in the file system 152 provided in the back-end system 150. More particularly, the user n template 210 preferably contains a # include file reference to a header file 310, a # include file reference to a footer file 320 and a # include file reference to a body file 330. An actual top level user template 210 can be seen in Appendix A, as can hierarchical header and footer files.

FIG. 3 illustrates the hierarchical format of the header or footer files 310 and 320 respectively. More particularly, from FIG. 3 it will be seen that each user specific header and footer file may contain further # include file references to fixed content 340 being content which is predetermined by the portal website manager, and user defined content 350 which is pre-selected by the user upon registration with the portal website. As will be seen, each of the fixed content 340 or the user defined content 350 may be contained in separate files which are referenced in the header and footer files by means of # include commands.

With reference to the fixed content 340 it will be seen that this may include content from the legacy database 156 or the file system 152 contained in the back-end system 150, or may include content from a remote web server. Furthermore, the content 342 from the website's own database may be referenced by means of a # include command, and the content 344 from remote servers may also be referenced by means of # include commands.

With respect to the information content 342 provided from the website's own database, as described in WO-A-0133388 such content may take three forms, being static content 3421 which is not changed over time, semi-static content 3422, such as, for example bank account details, or dynamic content 3423 which must be dynamically generated by the application server 154. As mentioned in WO-A-0133388 semi-static web-pages are batch processed on a periodic basis to update the data contained therein to match that of the legacy database, whereas dynamic web-pages are generated on the fly using a mail-merge technique which extracts data from the legacy database, and merges it into web-page component templates.

With respect to remote content 344 which is to be obtained from remote servers, preferably all that is included is the URL link to the remote server for the user browsers to connect to the remote web server to retrieve the content therefrom. This has the advantage that the portal page builder module of the present invention does not have to obtain content from the remote content suppliers prior to building each portal web-page, thus allowing each page to be compiled in as short a time as possible.

Turning now to the user defined content 350, it will be seen from FIG. 3 that this also takes a hierarchical format by including # include file references to data to be provided from the website's own back-end database, or from the remote servers. Where content has been provided from the website's own database, as with the fixed content this content may be static, semi-static, or dynamic, as described above. Similarly, where the user defined content is to be obtained from a remote server, preferably the reference file pointed at by the # include command contains merely the universal resource locater link to the remote server.

FIG. 4 illustrates how each referenced body file 330 may further include # include file references to individual body page files 332, 334, 336. That is, each user specific web-page may contain one or more main body pages, and furthermore each body page may be in a different mark-up language. In particular, it is envisaged that for instance a first page may be in HTML for a display using a standard web browser, a second page may be in XML in order to allow data exchange of the data content included on the page with a technology partner with whom an XML standard has been agreed, and a third page may be in WML in order to allow display of the page on a WAP phone.

FIG. 5 is intended to illustrate how each page is further hierarchically structured by means of # include file reference commands into n columns, each of which may include fixed content from the website's own database or from remote servers, and user defined content also from the website's own database or from remote servers. In particular, a user page n 336 may include a plurality of n columns 510, each of which may include fixed content 520 and user defined content. As described previously, the fixed content may be content 522 from the website's own database, in which case it may be either static, semi-static, or dynamic, or may instead be remotely referenced content 524 from a remote server. Similarly, the user defined content may also include file references to content from the website's own database, or file references to remote content to be obtained from a remote web server.

By reviewing all of FIGS. 2 to 5 it should be apparent that the individual page component data structures are arranged in a hierarchical manner from the top level user template at the route of the hierarchy, then referenced to data structures forming web-page components obtained either from the website's own database, or content from a remote server. It will be further apparent that the hierarchy may have many levels, and at each level may be either a file reference to a lower level, the actual reference data structure or a pointer thereto or a combination of each. When compiling the user specific web-page source code, the portal page builder module sequentially works through the hierarchy in turn travelling from the route of the hierarchy in the user template 210 to the actual reference data structure which is then either included in the source code directly, or a pointer or link thereto written into the source code.

Whilst FIGS. 3 and 5 have depicted the hierarchical structure in the form of the fixed content being above the user-defined content, this is for graphical illustration purposes only, and it is possible for the fixed content references and user-defined content references to be in any order at the same horizontal level, and for a plurality of references of each type to be included. Furthermore, file or data structure references can be interleaved with actual web-page source code within the same file. As an example, consider an example user body page file below:

user_n_body_page_1

# include user_n_user_def_1
(source code)
# include user_n_fixed_content_1
# include user_n_user_def_2

end

Here, the page builder module merely parses the file line-by-line to obtain the source code located at user_n_user_def_{—}1, which is then followed by the source codes already included in the user_n_body_page_{—}1 file, and then subsequently followed in order by the referenced code at user_n_fixed_content_{—}1 and user_n_user_def_{—}2. The important operation is not the ordering of the references, but the line-by-line sequential parsing and execution of the # include commands to follow the file references.

Further details of how the portal page builder 104 actually compiles the pages will now be described with reference to FIGS. 6 and 7. In particular FIG. 6 shows the system block diagram of the system elements of the portal page builder, and FIG. 7 illustrates a flow diagram of how the user specific source code is compiled.

Referring first to FIG. 6, the portal page builder module 104 preferably comprises a page compiler 608 arranged to receive page component data structures or pointers to page component data structures, and to arrange them in order into source code, such as, for example HTML, XML, or WML source code. The page compiler communicates with a parser module 602 which is arranged to retrieve a specific user template from the user template storage means 106, and to parse the user template to determine the taxonomy of the hierarchical references contained therein. The parser 602 is arranged to control a web request generator 604 and an application server interface 606. The web request generator 604 is arranged to generate links to remote page content, the generated links then being passed to the page compiler for inclusion in the generated web-page source code. The application server interface 606 is arranged to interface with the application server 154 provided in the back-end system 150 in order to obtain data content from the back-end system 150 which may be in the form of static web-page components, semi-static web-pages or web-page components, or dynamic web-pages or web-page components, as described in WO-A-0133388. When the application server interface 606 has retrieved a web-page component from the back-end system 150, it passes the retrieved component to the page compiler 608 for incorporation into the generated web-page source code.

The operation of the portal page builder module 104 will now be described in more detail with reference to the flow diagram of FIG. 7.

Here, suppose a user n has transmitted a request for the user specific portal web-page, and the request is received at the web server 102. The web server 102 passes the user page request at step 701 to the page compiler 608, which is arranged to control the parser module 602 to retrieve the specific user template from the user template storage means 106. The parser module receives the specific user template at step 702, and proceeds to parse the user template line-by-line at step 703. Therefore, in the first iteration of the outer loop of FIG. 7 the first line of the user template is executed, and with reference to FIG. 2 it will be seen that this is a # include command to include the user n header file. The user n header file referred to as the “referenced file” in FIG. 7 is then retrieved either from the user template storage means 106 or from the file system provided in the back-end system 150, and passed to the parser 602 for analysis at step 704. With reference to FIG. 3, it will be seen that the user n header or footer file may contain further # include commands to fixed content or user defined content, and that such fixed or user defined content may be from the website's own database or from a remote server. An evaluation is then performed at step S711, 721 or 731 to determine whether the first line of the header file is to obtain content from a remote source, to obtain fixed content, or to obtain content from one of the website's own database, and the appropriate steps performed as described next.

Suppose, for instance, the first line of the user n header file is to obtain content from a remote source, then the parser determines this at step S711, and passes information obtained from the file referenced by the # include to the web request generator 604 who generates the appropriate URL which is passed to the page compiler 608 for inclusion in the user specific web-page source code at step S705.

If it is determined that the content to be retrieved is fixed content, then the fixed content is retrieved from the file system as step 723 and this is passed to the page generator at step 705.

If it is determined that content is to be retrieved from the legacy database, then the application server interface interfaces with the application server at step 733 to control the database access means to retrieve the data phase from the legacy database 156. The application server then performs a merge to place the retrieved data into a web-page component template, and passes the web-page component template included the data to the application server interface at step 735, and then this is passed from the application server interface to the page compiler at step 705. Having passed the generated content to the page compiler, an evaluation is then made at step 706 to see if the end of the reference file, being in this case the header file is reached, then if not processed it returns to step 704 and is repeated until the end of the reference file is reached. Processing then proceeds to the evaluation of the end of the user template at step 707. If the end of the user template is not reached the parser 602 then parses the next line of the top level user template and the reference file is then obtained from the file system, and similarly parsed line-by-line as described above. Processing then repeats as described above for each line of each file until the end of the user template file is reached, whereupon it should be apparent that the page compiler 608 will then have sequentially received all of the web-page component data structures, and is then possible to compile the web-page component data structures into an integrated web-page, preferably by a merge technique into a template. This is achieved at step 708, and the page is then passed from the portal page builder module 104 to the web server 102 as step 709 for transmission over the Internet to the user.

While FIG. 7 shows only two nested loops, it will be apparent to the man skilled in the art that as many nested loops will be created in the process flow as there are # include command levels in the hierarchy. That is, if, for example, the file referenced from the top level user template includes further file references, then an additional nested loop will be included, and if that second file referenced from the first referenced header file contains further # include file references, then another nested loop will also appear in the process flow inside the outer loops and so on. In this manner, web-page component data structures are hierarchically retrieved and passed to the page compiler 608 in order such that all the page compiler has to do is merge the received data structures or pointers to data structures together in order to create the dynamic web-page. Such processing has the advantage that it can be performed quickly thus allowing the system to serve large numbers of multiple concurrent users.

In an alternative embodiment, an additional step can be included after step 713 wherein the URL request is generated by the web request generator 604, in that it may be possible for the web request generator to pass the URL to the web server to retrieve the content from the remote content supplier, the retrieved content then being passed to page compiler 608 for direct inclusion in the web-page source code. This has the advantage that the source code passed to the user is complete in that it includes all of the requested content, with the disadvantage that page generation time may be significantly increased as it then becomes dependent upon the response time of the web server of the remote content supplier.

It should be apparent from the above description, that the present invention provides a structured and hierarchical methodology for dynamically generating user specific web-pages, which allows for personal user data to be merged with fixed content which can be obtained from local storage, or provided with links to remotely stored content. The hierarchical structured approach to web-page generation embodied by the present invention allows for many thousands of multiple concurrent users to be serviced at any one time.

[image]

[image]

[image]

[image]

[image]

[image]

[image]

1. A method of dynamic web-page generation comprising steps of:
retrieving a user template from a database, said template containing one or more web page component data structures;
parsing the retrieved user template sequentially to determine the taxonomy of the hierarchical references; and
compiling at least a pointer to each referenced page component data structure sequentially in accordance with the taxonomy of the hierarchical references to create a web-page containing at least one pointer to each of the referenced data structures,
wherein each page component data structure is one of a locally stored pre-created structure, a dynamically created structure, or remotely stored structure.

2. A method according to claim 1 wherein, the hierarchical references have multiple levels, and each referenced data structure is at a different hierarchical level to other referenced data structures.

3. A method according to claim 1 wherein a hierarchical reference points to an executable command which upon execution dynamically creates a page component data structure which is compiled into the web-page.

4. A method according to claim 3 wherein, the content of the referenced data structure is directly incorporated into the generated web-page source code.

5. A method according to claim 3 wherein, the page component data structures pointed to by the hierarchical references are remote web-page components provided on a remote website operated by a content supplier.

6. A method according to claim 5 wherein, the hierarchical reference includes the universal resource locater of the website of the content supplier.

7. A method according to claim 6 wherein, the universal source locater is compiled into the web-page rather than the actual page component data structure pointed at by the universal resource locater.

8. A method according to claim 3 wherein, the page component data structure is a static data structure which is periodically batch updated.

9. A method according to claim 3 wherein, the page component data structure is a semi static data structure which is periodically batch updated.

10. A method according to claim 1 wherein, user specific information is stored on a legacy database.

11. A method according to claim 1 wherein, an application server is provided to access information from the database to form the page component data structures which are compiled into the web-page.

12. A system providing dynamic web-page generation, the system comprising:
user template storage means arranged to store one or more user templates, each template containing one or more hierarchical references to one or more page component data structures;
parsing means arranged to retrieve a user template from the user template storage means, and to parse the retrieved user template sequentially to determine the taxonomy of the hierarchical references stored therein; and
page compiler means arranged to compile at least a pointer to each reference page component data structure sequentially in accordance with the taxonomy of the hierarchical references determined by the parser means, to create a web-page containing at least a pointer each referenced data structure; and
a local file system means arranged to store page component data structure thereon;
wherein each page component data structure is one of a locally stored pre-created structure, a dynamically created structure, or a remotely stored structure.

13. A system according to claim 12 wherein, a database contains user specific personal information.

14. A system according to claim 12 and 13 wherein, an application server is arranged to:
access the database to retrieve user specific personal information therefrom; and
create page component data structures containing the retrieved user specific personal information.

15. A system according to claim 14 wherein, an application server saves the created page component data structures in the local file system storage means.

16. A computer readable storage medium storing a computer program which when loaded into a computer is arranged to control the computer to perform the method steps of claim 1.
